(19) United States
(12) Patent Application Publication
(10) Pub. No.: US 2025/0119991 A1
(43) Pub. Date: Apr. 10, 2025

(54) OPERATING METHOD FOR AN ARC FURNACE

(71) Applicant: Primetals Technologies Germany GmbH, Erlangen (DE)

(72) Inventors: Thomas MATSCHULLAT, Eckental (DE); Günther WINTER, Neunkirchen/Brand (DE)

(21) Appl. No.: 18/835,997

(22) PCT Filed: Feb. 7, 2023
(86) PCT No.: PCT/EP2023/052904

§ 371 Date: Aug. 5, 2024

(30) Foreign Application Priority Data
Feb. 15, 2022 (EP) 22156810.8

(51) Int. Cl. H05B 7/148; F27B 3/08; F27B 3/28; H05B 7/20

(52) U.S. Cl. CPC H05B 7/148; F27B 3/085; F27B 3/28; H05B 7/20

(57) ABSTRACT

A furnace vessel of an arc furnace is loaded with solid metal. Afterward, an energy supply device of the arc furnace feeds electrical energy to electrodes of the arc furnace via a furnace transformer to form arcs between the electrodes and the metal, the arcs melting the metal. Finally, the molten metal is removed from the furnace vessel. The number of electrodes is at least three. For at least two of the electrodes, the energy supply device individually sets the operating frequency (fa, fb) of the relevant electrode. The current (Ic) through the third electrode is defined by the current (Ia, Ib) through the first and the second electrodes. Which of the electrode is the first electrode, which is the second electrode, and which is the third electrode is assigned dynamically.

### TECHNICAL FIELD

The present invention takes an operating method for an electric arc furnace as starting point, a power supply device of the electric arc furnace drawing electrical energy from a supply system between charging of a furnace vessel of the electric arc furnace with metal in solid aggregate state and removal of a metal melt from the furnace vessel and supplying the drawn electrical energy via a furnace transformer to at least one first, one second and one third electrode of the electric arc furnace, so that electric arcs form between the electrodes and the metal or the metal melt, by means of which electric arcs the metal is melted to form the metal melt, the power supply device adjusting an operating frequency of the first electrode and an operating frequency of the second electrode individually, so that the current through the third electrode is determined by the current through the first and the second electrode.

The present invention furthermore takes a control program for a control device of an electric arc furnace as a starting point, wherein the control program comprises machine code that can be executed by the control device, wherein the execution of the machine code by the control device causes the control device to operate the electric arc furnace according to an operating method of this type.

The present invention furthermore takes a control device of an electric arc furnace as a starting point, wherein the control device is programmed with a control program of this type, so that the execution of the machine code by the control device causes the control device to operate the electric arc furnace according to an operating method of this type.

The present invention furthermore takes an electric arc furnace as a starting point,
wherein the electric arc furnace has a furnace vessel which can be charged with metal and from which a metal melt can be removed,
wherein the electric arc furnace has a power supply device and electrodes and also a furnace transformer,
wherein the power supply device is connected at the input side to a supply system and at the output side via the furnace transformer to the electrodes,
wherein the electric arc furnace has a control device, by which at least the power supply device can be activated,
wherein the control device is designed as explained above.

### PRIOR ART

The subjects mentioned are known for example from WO 2021/115 573 A1.

### SUMMARY OF THE INVENTION

During the melting of metal—particularly steel—in an electric arc furnace, the supply of the electrical energy to the electrodes of the electric arc furnace takes place by means of a furnace transformer. Often, the furnace transformer is connected to the supply system via a medium-voltage transformer. The furnace transformer provides a plurality of voltage steps. For the range of constant power and other high-current ranges, the respective voltage step can be chosen at the furnace transformer. Fine control within a certain voltage step can for example take place by means of impedance control.

In this approach, only a few voltage steps are possible and the electrode currents are subject to strong fluctuations. To reduce the fluctuations, the positionings of the electrodes is controlled mechanically, for the most part by means of hydraulic adjusting devices. The mechanical adjustment of the electrodes has considerably smaller dynamics than the real behavior of the electric arcs. The fluctuations can therefore only be compensated for unsatisfactorily. Furthermore, the fluctuations lead to considerable loads of the components, for example the high current cables, the current-carrying brackets, the hydraulic cylinders, etc. The fluctuations occur both in the melting phase and in a subsequent flat-bath phase.

During the adjustment of the electrode voltage via the voltage steps of the furnace transformer, the positioning of the electrodes must be continually readjusted. The readjustment can for example take place in such a manner that control is carried out to a certain impedance or a certain power. As the dynamics of the positioning device is relatively low compared to the changes in the electrical system of the electric arc however, certain fluctuations remain, which cannot be compensated for. As a result, the energy input into the steel melt is not optimal.

Approaches are known from the documents of the prior art, particularly from WO 2015/176 899 A1 and EP 3 124 903 A1 and to a limited extent also from EP 1 026 921 A1, in which the electrode voltages can be adjusted continuously. These embodiments offer considerable advantages compared to adjusting the electrode voltage by means of voltage steps of the furnace transformer. Thus, the electrode voltages can be varied not only step-by-step, but rather continuously. Furthermore, the furnace transformer can be designed more simply, because it does not have to provide a plurality of voltage steps. Furthermore, the adjustment of the electrode voltages is possible considerably more dynamically than the positioning of the electrodes. Finally, further types of control are enabled by these embodiments.

In spite of the flexibility in operating the electric arc furnace, which is achieved due to the possibility of continuously adjusting the electrode voltages, the operation of the electric arc furnace in the prior art is often still not optimum. For example, suboptimal energy input into the metal or the metal melt and also electric arc breakdowns can still occur.

The object of the present invention consists in creating options, by means of which the disadvantages of the prior art can be avoided.

The object is achieved by an operating method having the features of claim 1. Advantageous embodiments of the operating method are the subject of the dependent claims 2 to 11.

According to the invention, an operating method of the type mentioned in the introduction is configured in that electrodes of a totality of electrodes of the electric arc furnace are dynamically allocated to which of them is the first electrode, which of them is the second electrode and which of them is the third electrode.

As a result, the respective operating frequency can be adjusted optimally, at least for the first and the second electrode, for the actual operation of the respective electrode.

It is possible that the operating frequencies of the first and the second electrode are the same. This is only the case however if the same values result by chance owing to the individual adjustment of the operating frequencies. Generally, the operating frequencies for the first and the second electrode differ from one another however.

It is possible that the operating frequency of the first electrode is constant over time. Generally, however, better operation of the electric arc furnace results if the operating frequency of the first electrode varies over time. Preferably, the operating frequency of the first electrode varies depending on a process status of the electric arc furnace. The process state can in particular be determined by evaluating electrical or acoustic operating variables of the electric arc furnace. The same approach can of course also be taken for the second electrode.

It is possible that the operating frequency of the second electrode is adjusted independently of the operating frequency of the first electrode. Often however, it is advantageous if the operating frequency of the second electrode is adjusted while taking the operating frequency of the first electrode into account. For example, the operating frequency of the second electrode can be adjusted in such a manner that it has a certain distance from the operating frequency of the first electrode. Also, although the operating frequency of the second electrode is initially determined independently of the operating frequency of the first electrode, the operating frequency determined in this manner is only adopted if it at least has the certain distance from the operating frequency of the first electrode and otherwise the operating frequency of the second electrode is adjusted so that it has the certain distance from the operating frequency of the first electrode.

Therefore in the present invention, the respective status as first, second and third electrode—in each case considered for the time period between the charging of the furnace vessel with metal and the removal of the metal melt from the furnace vessel—is not determined once statically, but rather changed from time to time. One and the same electrode of the electric arc furnace can therefore be the first electrode at one particular time, the second electrode at a different time and neither the first nor the second electrode at a further different time. If, in the case of three electrodes of the electric arc furnace in total at one particular time x, electrode a is operated with a frequency fa and electrode b is operated with a frequency fb and the current through electrode c is determined by the current through the electrodes a and b, for example at a later time y, electrode b can be operated with the frequency fa and electrode c can be operated with the frequency fb and consequently the current through electrode a can be determined by the current through the electrodes b and c. The transitions can take place abruptly or continuously, sinusoidally in particular in the last-mentioned case.

The electrodes of the electric arc furnace are generally height adjustable. In this case, it is possible that the electrodes are height adjustable only together or independently of one another. In the case of independent adjustability, the dynamic allocation of the respective “role” to the electrodes can be combined with an approach in which the positioning of the respective electrode of the electric arc furnace is determined depending on whether it is the first, the second or the third electrode. The term “depending” should not mean that the “role” of the respective electrode determines the positioning of the respective electrode completely. Rather, it is sufficient that the “role” of the respective electrode is also taken into account.

To realize an individual height adjustability, it may already be sufficient if, in addition to a common adjustment of the electrodes, only a slight overlay of an additional movement of the individual electrodes is possible. In this case, if there are n electrodes, only n−1 devices are needed for effecting the additional movements.

Between charging the furnace vessel with the metal and removal of the metal melt from the furnace vessel, the electric arc furnace is initially operated in a melting phase and then in a flat-bath phase. In the melting phase, the metal is melted to form the metal melt. The melting phase can for its part be divided into an initial phase and an end phase. The initial phase is often termed the melt-down phase. The majority of the melting of the metal takes place in the end phase. In the flat-bath phase, the metal melt is heated further.

Furthermore, in some cases the charging of the furnace vessel with the metal is very inhomogeneous, so larger metal pieces are located in the region below an electrode and smaller metal pieces are located in the region below a different electrode. In this case, it may be advantageous to determine the operating frequency of the first electrode during the melting phase depending on the size of the pieces of the metal to be melted by means of the first electrode. The operating frequency of the first electrode can in particular be determined in such a manner during the melting phase that it is smaller, the larger the pieces of the metal to be melted by means of the first electrode. Preferably, the operating frequency of the first electrode during the melting phase or during an end phase of the melting phase is furthermore greater than a mains frequency, using which the supply system is operated, particularly at least 10 Hz greater. The same approach can of course also be taken for the second electrode.

Preferably, electrical energy supplied to the electrodes is determined in such a manner that the electrodes in each case input the same amount of energy, averaged over time, into the metal or the metal melt. The average over time is here not formed over a single period of the respective operating frequency of the respective electrode, but rather over the entire operation of the electrodes between the charging of the furnace vessel with metal and the removal of the metal melt from the furnace vessel or at least over an operating phase of the electric arc furnace (initial phase of the melting phase, end phase of the melting phase and flat-bath phase or melting phase and flat-bath phase). As a result, an averaging of the temperature of the metal melt can be achieved in particular.

The object is furthermore achieved by a control program having the features of claim 12. According to the invention, the execution of the machine code by the control device preferably causes the control device to operate the electric arc furnace according to an operating method according to the invention.

The object is furthermore achieved by a control device having the features of claim 13. According to the invention, the control device is programmed with a control program according to the invention, so it operates the electric arc furnace according to an operating method according to the invention.

The object is furthermore achieved by an electric arc furnace having the features of claim 14. According to the invention, the control device is designed as a control device according to the invention.

### BRIEF DESCRIPTION OF THE DRAWINGS

The above-described properties, features and advantages of this invention and the manner in which these are achieved become clearer and more clearly understandable in connection with the following description of the exemplary embodiments that are explained in more detail in connection with the drawings. In the figures, in schematic illustration:

FIG. 1 shows a block circuit diagram of an electric arc furnace,

FIG. 2 shows a furnace vessel during a melting phase,

FIG. 3 shows a flowchart,

FIG. 4 shows the furnace vessel during a flat-bath phase,

FIG. 5 shows a flowchart,

FIG. 6 shows a time graph,

FIG. 7 shows a further time graph, and

FIG. 8 shows a functional dependence.

### DESCRIPTION OF THE EMBODIMENTS

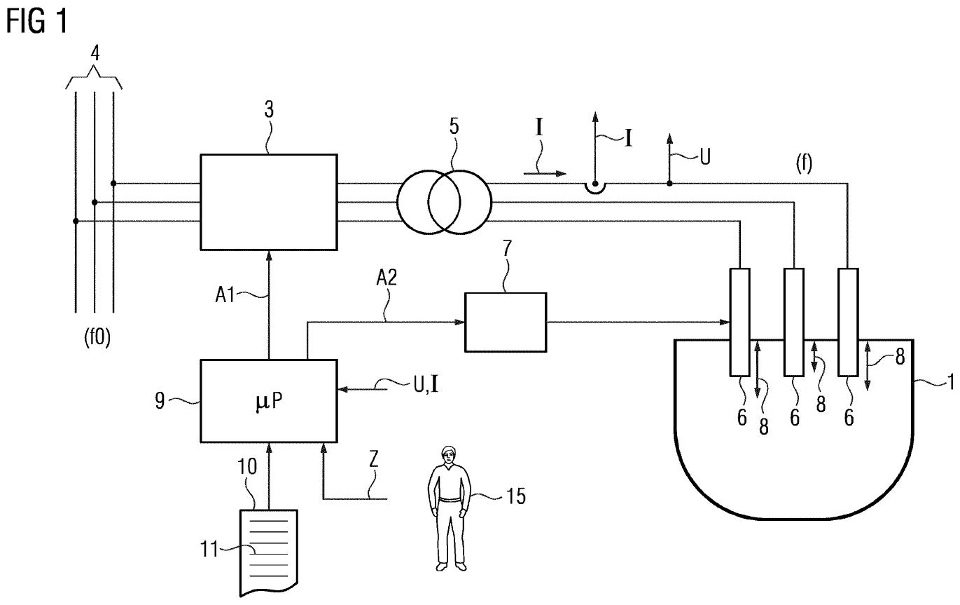

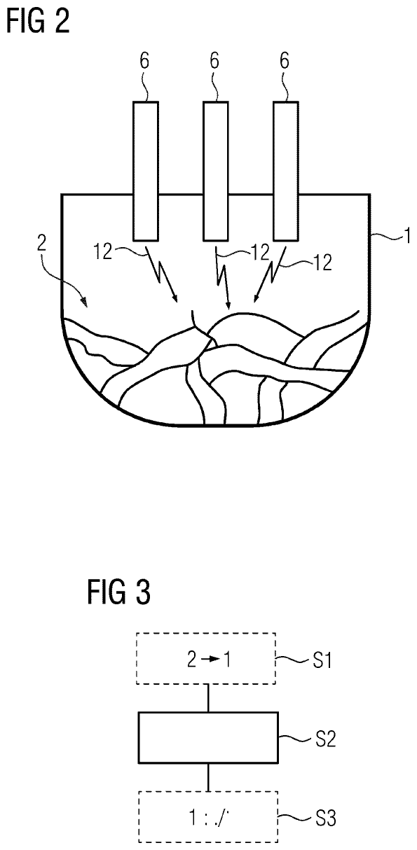

According to FIG. 1, an electric arc furnace has a furnace vessel 1. The furnace vessel 1 can—see FIG. 2—be charged with metal 2. The metal 2 is supplied to the furnace vessel 1 in solid aggregate state during charging. The metal 2 can for example be steel and in the case of steel, scrap in particular.

The electric arc furnace furthermore has a power supply device 3. The power supply device 3 is connected at the input side to a supply system 4. The supply system 4 is generally a medium-voltage system which has a nominal voltage in the 2-digit kV range and is operated with a mains frequency f0. The mains frequency f0 is generally 50 Hz or 60 Hz. According to the illustration in FIG. 1, the supply system 4 is generally a three-phase system.

The electric arc furnace furthermore has a furnace transformer 5 and electrodes 6. The power supply device 3 is connected at the output side to the electrodes 6 via the furnace transformer 5. In the context of the present invention, at least three electrodes 6 are present. Often, exactly three electrodes 6 are present. Furthermore, the furnace transformer 5 is generally designed as a three-phase transformer. Independently of the actual embodiment, electrode voltages U that are applied to the electrodes 6 are clearly below the nominal voltage of the supply system 4 however. The electrode voltage U is only illustrated for one of the electrodes 6 in FIG. 1. For the most part, the electrode voltages U are in the range of several 100 V. Voltages above 1 kV are also possible in particular cases. 2 kV is generally not exceeded however.

Generally, switching equipment is furthermore present, by means of which the power supply device 3 can be disconnected from the supply system 4. Furthermore, switching equipment may be present, by means of which the power supply device 3 can be disconnected from the furnace transformer 5 and/or the furnace transformer 5 can be disconnected from the electrodes 6. The switching equipment carries out purely binary switching operations, but no adjustment of voltages and currents. Furthermore, active or passive filter devices may be arranged on the primary side or secondary side of the furnace transformer 5. The switching equipment and also the filter devices are of subordinate importance for the functionality according to the invention and therefore not also illustrated in FIG. 1 (and also the other FIGS) for the sake of clarity.

The power supply device 3 can draw electrical energy from the supply system 4 and supply the electrical energy drawn to the electrodes 6 via the furnace transformer 5. The power supply device 3 generally has many semiconductor switches for this purpose. Possible embodiments of the power supply device 3 are described in WO 2015/176 899 A1 (“gold standard”). Alternatively, the embodiments according to EP 3 124 903 A1 or EP 1 026 921 A1 may for example also be used. Independently of the actual embodiment of the power supply device 3, the power supply device 3 is however able at the output side—that is to say toward the furnace transformer 5—to perform an almost continuous stepping of the electrode voltages U applied to the electrodes 6 and/or the electrode currents I supplied to the electrodes 6. Analogously to the illustration for the electrode voltages U, the electrode current I is likewise only illustrated for one of the electrodes 6 in FIG. 1. Also, a respective operating frequency f, with which the electrode voltages U applied to the electrodes 6 or the electrode currents I supplied to the electrodes 6 vary, can be adjusted by means of the energy supply device 3. The respective operating frequency f can, if required, be above or below the mains frequency f0.

Furthermore, the electric arc furnace has a positioning device 7. By means of the positioning device 7, the electrodes 6 can be positioned as is indicated in FIG. 1 by double arrows 8 next to the electrodes 6. In the simplest case, the electrodes 6 are positioned together. Preferably however, an individual positioning of the electrodes 6 takes place. This is indicated in FIG. 1 in that the double arrows 8 are of different lengths. The movement direction in which the electrodes 6 are positioned can be vertical. Alternatively, the movement direction may also be slightly inclined with respect to the vertical. Even in this case however, the component in the vertical direction is the dominant component of the movement. The positioning device 7 may for example have one or more hydraulic cylinder units.

Finally, the electric arc furnace has a control device 9. At least the power supply device 3 is controlled by the control device 9. The control device 9 generates activation values A1, using which it activates the power supply device 3. The power supply device 3 is operated in accordance with the activation values A1.

Often, the positioning device 7 is also controlled by the control device 9; in this case, the control device 9 generates further activation values A2, using which it activates the positioning device 7. In this case, the power supply device 7 is operated in accordance with these activation values A2.

The control device 9 is designed as a software-programmable control device. This is indicated in FIG. 1 by the information “μp” (for microprocessor-controlled). The mode of action and operation of the control device 9 is determined by a control program 10, using which the control device 9 is programmed. The control program 10 comprises machine code 11 that can be executed by the control device 9. The execution of the machine code 11 by the control device 9 causes the control device 9 to operate the electric arc furnace according to an operating method, as is explained in more detail in the following in connection with the further FIGs.

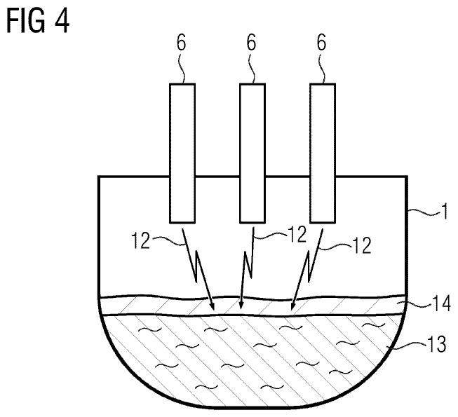

According to FIG. 3, the furnace vessel 1 is initially charged with the metal 2 in a step S1. FIG. 2 shows the state after the charging of the furnace vessel 1 directly after the ignition of electric arcs 12 (see FIGS. 2 and 4) by corresponding activation of the power supply device 3 by the control device 9.

Then, the actual operation of the electric arc furnace takes place in a step S2. The application of the electrode voltages U and the supply of the electrode currents I to the electrodes 6 takes place in the context of step S2. As a result, the electric arcs 12, by means of which the metal 2 is melted to form a metal melt 13, form initially between the electrodes 6 and the metal 2. This operating phase of the electric arc furnace is generally termed the melting phase. It can be divided into an initial phase and an end phase, wherein the initial phase is for the most part termed the melt-down phase and the end phase is termed the main melting phase. Then, the electric arcs 12 form between the electrodes 6 and the metal melt 13, so that the metal melt is heated further. This operating phase of the electric arc furnace is generally termed the flat-bath phase. This state is illustrated in FIG. 4. In the flat-bath phase, the metal melt 13 may be covered at its upper side by a slag layer 14. The slag layer 14 may be a foamed slag.

Finally, in a step S3, the metal melt 13 that is created is removed from the furnace vessel 1, for example poured into a ladle (not illustrated).

The step S2, that is to say the actual operation of the electric arc furnace, takes place by corresponding activation of the power supply device 3. The steps S1 and S3 can likewise take place under control by the control device 9.

They do not have to take place under control by the control device 9 however. The steps S1 and S3 are therefore only illustrated dashed in FIG. 3.

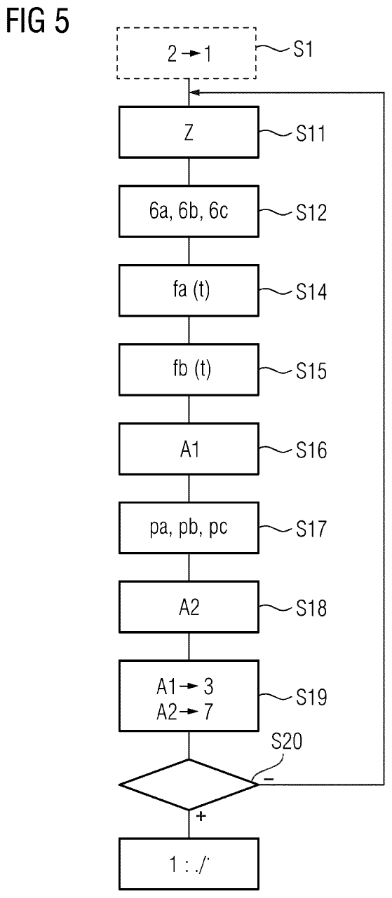

In the following, step S2, that is to say the actual operation of the electric arc furnace between the charging of the furnace vessel 1 with the metal 2 and the removal of the metal melt 13 from the furnace vessel 1, is explained in more detail in connection with FIG. 5. The step S2 is divided into steps S11 to S20 for this purpose. Furthermore, in the context of the further explanation, a distinction is made between the individual electrodes 6. For this purpose, the electrodes 6 are additionally in each case assigned a small letter according to their sequence if a distinction should be made between the individual electrodes 6. In this case, the electrodes 6 are designated first electrode 6a, second electrode 6b and third electrode 6c. If by contrast, only the electrodes 6 in general are discussed, only the general reference sign 6 is also used. The same is true for the electrode-specific variables such as for example the electrode voltages U, the electrode currents I and the operating frequencies f.

According to FIG. 5, the control device 9 determines a state Z of the electric arc furnace in step S11. The state Z indicates the extent to which the operation of the electric arc furnace between the charging with the metal 2 and the removal of the metal melt 13 has advanced. In the simplest case, the state Z of the control device 9 is predetermined by an operator 15 (see FIG. 1). Alternatively, it is possible that the control device 9 determines the state Z directly on the basis of the time t that has elapsed since the initial ignition of the electric arcs 12 after the charging of the furnace vessel 1. Preferably however, in step S12, the control device 9 evaluates actual values of the electric arc furnace that are detected metrologically. For example, it is possible that the control device 9 evaluates the electrode currents I and/or the electrode voltages U, particularly the fluctuations thereof. Also, the control device 9 can evaluate acoustic values of the electric arc furnace, for example the noise level or the acoustic spectrum of the noise generated.

In step S12, the control device 9 determines which of the electrodes 6 is the first electrode 6a, the second electrode 6b and the third electrode 6c. The determination can take place in direct dependence on the time t that has elapsed since the initial ignition of the electric arcs 12 after the charging of the furnace vessel 1. Alternatively, it can take place in direct dependence on the time that has elapsed since the start of the respective state Z. In the two last-mentioned cases, the electrodes 6 are therefore dynamically allocated to which of them is the first electrode 6a, which of them is the second electrode 6b and which of them is the third electrode 6c. The electrodes 6 can therefore exchange their roles from time to time.

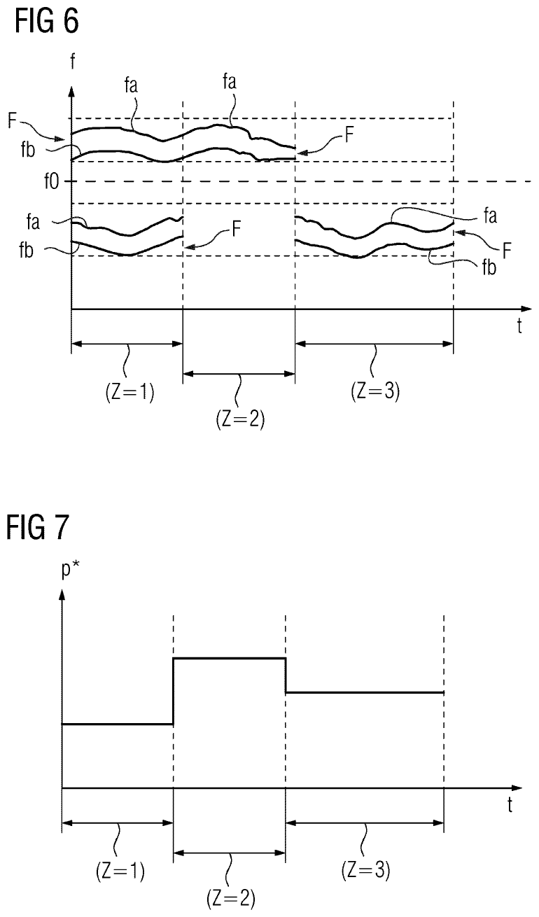

In step S13, the control device 9 determines a frequency range F, in which the electrode currents I and/or the electrode voltages U should be. The frequency range F can in particular be dependent on the state Z. For example, it is possible according to the illustration in FIG. 6 that during the end phase of the melting phase (state Z=2), the frequency range F exclusively comprises frequencies f that are greater than the mains frequency f0. Likewise, it is possible that during the flat-bath phase (state Z=3), the frequency range F exclusively comprises frequencies f that are lower than the mains frequency f0. Finally, it is possible that during the initial phase of the melting phase (state Z=1), the frequency range F alternatively exclusively comprises frequencies f that are greater than the mains frequency f0 or exclusively comprises frequencies f that are lower than the mains frequency f0.

Preferably, the frequency range F always has a certain minimum distance from the mains frequency. The minimum distance can for example be between 7 Hz and 13 Hz, particularly approximately 10 Hz. If the frequency range F is above the mains frequency f0, a lower limit frequency of the frequency range F for a mains frequency f0 of 50 Hz is therefore preferably “somewhere” between 57 Hz and 63 Hz, for example 60 Hz. Analogously, if the frequency range F is below the mains frequency f0, an upper limit frequency of the frequency range F for a mains frequency f0 of 50 Hz is therefore preferably “somewhere” between 37 Hz and 43 Hz, for example 40 Hz. For a mains frequency f0 of 60 Hz, 10 Hz must be added to the limit frequencies mentioned in each case.

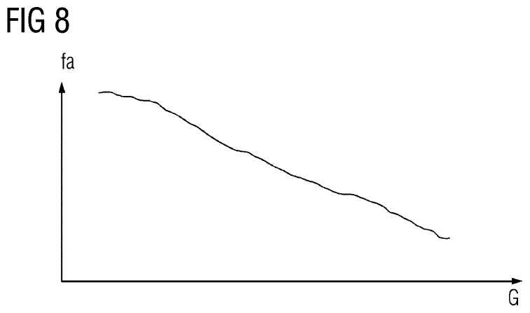

Preferably, according to the illustration in FIG. 7, the power P* to be input into the metal 2 or the metal melt 13 is adjusted as a function of time t, actually depending on the state Z. FIG. 7 shows the preferred embodiment, according to which the power P* to be input during the initial phase of the melting phase (state Z=1) has a relatively low value, during the end phase of the melting phase (state Z=2) has a relatively high value and during the flat-bath phase (Z=3) has a value between the value of the initial phase and the end phase of the melting phase.

In step S14, the control device 9 determines an operating frequency fa for the first electrode 6a. The determination takes place in such a manner that the operating frequency fa is within the presently valid frequency range F. The operating frequency fa can be static. Alternatively, it may admittedly be static within the respective state Z, but depend on the state Z. In turn, alternatively, it may—see FIG. 6—also depend on the time within the respective state Z, for example on process progress. For the state Z=1, possible time curves of the operating frequency fa both for the frequency range F above and for the frequency range F below the mains frequency f0 are plotted in FIG. 6. In practice of course, only one of the two operating frequencies fa is valid.

In step S15, the control device 9 determines an operating frequency fb for the second electrode 6b. The determination takes place individually to the extent that the operating frequency fb does not necessarily have to match the operating frequency fa. The operating frequency fb can therefore be different from the operating frequency fa.

It is possible that the determination of the step S15 takes place independently of the determination of the step S14. However, a certain dependence may also exist. For example, it may be required that the operating frequency fb of the second electrode 6b complies with a minimum distance from the operating frequency fa of the first electrode 6a. Alternatively, it may be required that the operating frequency fb of the second electrode 6b is within the presently valid frequency range F. Otherwise, the embodiments for determining the operating frequency fa of the first 6a can be applied analogously.

For the third electrode 6c, it is no longer possible to determine an operating frequency. This is because the mode of operation of the third electrode 6c is determined in that the currents I through the electrodes 6a, 6b, 6c (taking account of the sign of the currents I) must add up to zero at all times.

In step S16, the control device 9 determines the activation values A1 for the power supply device 3. The control device 9 takes account of the operating frequencies fa, fb of the first and the second electrode 6a, 6b in the determination of the activation values A1.

If the control device 9 also controls the positioning device 7, the control device 9 in step S17 determines positionings pa, pb, pc for the first, the second and the third electrode 6a, 6b, 6c. In this case, the control device 9 in step S18 determines the associated further activation values A2. It is possible that a uniform determination is carried out for all electrodes 6. Likewise, it is however also possible that the positionings pa, pb, pc take place individually depending on whether the respective electrode 6 is the first, the second or the third electrode 6a, 6b, 6c.

In step S19, the control device 9 activates the power supply device 3 in accordance with the determined activation values A1. If the control device 9 also controls the positioning device 7, in step S19, the control device 9 also activates the positioning device 7 using the further activation values A2.

In step S20, the control device 9 checks whether the respective cycle of operation of the electric arc furnace is finished, i.e. the metal 2 is completely melted to form the metal melt 13 and furthermore, the metal melt 13 is heated further, if required. If this is the case, the control device 9 transitions to step S3. Otherwise, the control device 9 returns to step S11.

FIG. 8 shows an option for determining the operating frequency fa of the first electrode 6a during the melting phase. The dependence according to FIG. 8 can alternatively exist during the entire melting phase or only during the initial phase or the end phase of the melting phase. According to FIG. 8, the control device 9 determines the operating frequency fa of the first electrode 6a depending on the size G of the pieces of the metal 2 to be melted by means of the first electrode 6. In particular, the operating frequency fa of the first electrode 6a may decrease with increasing size G of the pieces of the metal 2 monotonically or strictly monotonically. The operating frequency fa of the first electrode 6a is therefore preferably determined in such a manner during the melting phase that it is smaller, the larger the pieces of the metal 2 to be melted by means of the first electrode 6a. An analogous approach can of course also be taken for the second electrode 6b and its operating frequency fb. In the case of the approach according to FIG. 8—depending on the size G of the pieces of the metal 2—different or the same operating frequencies fa, fb can result. The size G utilized can for example be a statistical average value of the sizes of the individual pieces of the metal 2. Alternatively, an extreme value (minimum or maximum) can be utilized.

The electrical energy supplied to the electrodes 6—that is to say the integral of the electric power supplied to the electrodes 6—is preferably determined by the control device 9 in such a manner that the electrodes 6 in each case input the same amount of energy, averaged over time, into the metal 2 or the metal melt 13. The average over time is here not formed over an individual period of the respective operating frequency fa, fb, but rather over a multiplicity of periods. Particularly preferably, averaging is over a respective operating phase of the electric arc furnace, that is to say either over the initial phase of the melting phase, the end phase of the melting phase and the flat-bath phase or over the melting phase and the flat-bath phase.

The present invention has many advantages. In particular, the operation of the electric arc furnace can be adapted to the requirements of the individual case in a flexible manner. Furthermore, the specific energy (for example kilowatt hours per tonne) required for creating a certain amount of a metal melt 13 can often be reduced and the cycle time can also often be reduced.

Although the invention was illustrated and described in detail by the preferred exemplary embodiment, the invention is not limited by the disclosed examples and other variants can be deduced from this by a person skilled in the art without departing from the protective scope of the invention.

### LIST OF REFERENCE SIGNS

1 Furnace vessel
2 Metal
3 Power supply device
4 Supply system
5 Furnace transformer
6 Electrodes
7 Positioning device
8 Double arrow
9 Control device
10 Control program
11 Machine code
12 Electric arcs
13 Metal melt
14 Slag layer
15 Operator
A1, A2 Activation values
f, fa, fb Operating frequencies
f0 Mains frequency
F Frequency range
G Size
I, Ia, Ib, Ic Electrode currents
pa, pb, pc Positionings
P* Power to be input
S1 to S20 Steps
t Time
U Electrode voltages
Z State

1. An operating method for an electric arc furnace, a power supply device of the electric arc furnace drawing electrical energy from a supply system between charging of a furnace vessel of the electric arc furnace with metal in solid aggregate state and removal of a metal melt from the furnace vessel and supplying the drawn electrical energy via a furnace transformer to at least one first, one second and one third electrode of the electric arc furnace, so that electric arcs form between the electrodes and the metal or the metal melt, by means of which electric arcs the metal-is melted to form the metal melt, the power supply device adjusting an operating frequency (fa) of the first electrode and an operating frequency (fb) of the second electrode individually, so that the current (Ic) through the third electrode is determined by the current (Ia, Ib) through the first and the second electrode, wherein electrodes of a totality of electrodes of the electric arc furnace are dynamically allocated to which of them is the first electrode, which of them is the second electrode and which of them is the third electrode.

2. The operating method as claimed in claim 1, wherein the operating frequencies (fa, fb) for the first and the second electrode differ from one another.

3. The operating method as claimed in claim 1, wherein the operating frequency (fa) of the first electrode varies over time.

4. The operating method as claimed in claim 3, wherein the operating frequency (fa) of the first electrode varies depending on a process status of the electric arc furnace.

5. The operating method as claimed in claim 4, wherein the process state is determined by evaluating electrical or acoustic operating variables of the electric arc furnace.

6. The operating method as claimed in claim 1, wherein the operating frequency (fb) of the second electrode adjusted while taking the operating frequency (fa) of the first electrode into account.

7. The operating method as claimed in claim 1, wherein the electrodes of the totality of electrodes of the electric arc furnace are height adjustable independently of one another and in that a positioning (pa, pb, pc) of the respective electrode of the electric arc furnace is determined depending on whether it is the first, the second or the third electrode.

8. The operating method as claimed in claim 1, wherein between charging the furnace vessel with the metal and removal of the metal melt from the furnace vessel, the electric arc furnace is initially operated in a melting phase and then in a flat-bath phase, in that metal is melted to form the metal melt in the melting phase and the metal melt is heated further in the flat-bath phase, and in that the operating frequency (fa) of the first electrode is determined during the melting phase depending on the size (G) of the pieces of the metal to be melted by means of the first electrode.

9. The operating method as claimed in claim 8, wherein the operating frequency (fa) of the first electrode is determined in such a manner during the melting phase that it is smaller, the larger the pieces of the metal to be melted by means of the first electrode.

10. The operating method as claimed in claim 8, wherein the supply system is operated with a mains frequency (f0) and in that the operating frequency (fa) of the first electrode during the melting phase or during an end phase of the melting phase is greater than the mains frequency(f0).

11. The operating method as claimed in claim 1, wherein electrical energy supplied to the electrodes is determined in such a manner that the electrodes in each case input the same amount of energy, averaged over time, into the metal or the metal melt.

12. A control program product for a control device of an electric arc furnace comprising a non-transitory computer-readable storage device and a control program stored on the non-transitory computer-readable storage device, wherein the control program comprises machine code that can be executed by the control device, wherein the execution of the machine code by the control device causes the control device to operate the electric arc furnace according to the operating method as claimed in claim 1.

13. A control device of an electric arc furnace, wherein the control device comprises a non-transitory computer-readable device storing a control program, so that the execution of the control program by the control device causes the control device to operate the electric arc furnace according to the operating method as claimed in claim 1.

14. An electric arc furnace,
wherein the electric arc furnace has a furnace vessel which can be charged with metal and from which a metal melt can be removed,
wherein the electric arc furnace has a power supply device and electrodes and also a furnace transformer,
wherein the power supply device is connected at the input side to a supply system and at the output side via the furnace transformer to the electrodes,
wherein the electric arc furnace has a control device, by which at least the power supply device can be activated,
wherein the control device is designed as claimed in claim 13.
